(19) United States
(12) Patent Application Publication
(10) Pub. No.: US 2005/0195259 A1
(43) Pub. Date: Sep. 8, 2005

(54) Discharge roller, conveyance apparatus, and recording apparatus

(75) Inventors: Naokazu Tanahashi, Nagoya-shi (JP); Masatoshi Izuchi, Nagoya-shi (JP)

Correspondence Address: BANNER & WITCOFF, LTD., ATTORNEYS FOR RESERVE;CLIENT NO. 7, 1001 G STREET, N.W., 11TH FLOOR, WASHINGTON, DC, 20001-4597, US

(73) Assignee: Brother Kogyo Kabushiki Kaisha, Nagoya-shi (JP)

(21) Appl. No.: 11/071,459

(22) Filed: Mar. 4, 2005

(30) Foreign Application Priority Data
Mar. 5, 2004 (JP) 2004-062828

(51) Int. Cl. B41J 2/01

(52) U.S. Cl. 347/101

(57) ABSTRACT

A discharge roller for discharging a sheet member having a predetermined width includes a shaft member and a pair of support members. The shaft member extends in a longitudinal direction. The pair of support members are disposed on the shaft member. One end of each support member in the longitudinal direction has a diameter equal to that of the shaft member. The other end of each support member has a diameter larger than that of the shaft member.

### BACKGROUND OF THE INVENTION

1. Field of the Invention

The present invention relates to a recording apparatus and a multifunction apparatus including the recording apparatus such as an inkjet printer and, more particularly, to a mechanism for discharging a sheet member, which is provided in these apparatuses.

2. Description of the Related Art

For example, an inkjet printer roughly has a sheet feed portion, a recording portion, and a sheet discharge portion. First, a recording medium serving as a sheet member is conveyed by a conveyance roller pair, which is provided in the sheet feed portion, and fed to the recording portion. Subsequently, ink is ejected in a recording region (for instance, a predetermined place on the top surface of a platen) of the recording portion from a recording head to thereby form an image on the recording medium. Finally, the recording medium, on which the image is formed (or recorded), is discharged by a discharge roller pair provided in the sheet discharge portion.

Hitherto, the recording mediums, on each of which an image is recorded, have consecutively been deposited in a stacked manner in such an inkjet printer. Thus, the inkjet printer has a problem that when the recording mediums are brought into contact with each other even though the ink has not dried, blurring and smearing of ink are caused.

To solve this problem, hitherto, there have been proposed various solutions. For example, U.S. Pat. No. 6,042,106 (FIG. 2) discloses an apparatus having the following configuration. That is, the apparatus ensures sufficient time to dry ink, which has been ejected onto a discharged recording medium, before subsequent other recording mediums falls onto the discharged recording medium by means of an edge guide mechanism that holds the discharged recording medium above an output tray until the discharged recording medium is released.

### SUMMARY OF THE INVENTION

However, such an edge guide mechanism has a complex configuration, as described in U.S. Pat. No. 6,042,106. Thus, the edge guide mechanism has problems that it is difficult to reduce a space needed for providing the edge guide mechanism, and that the cost thereof is high. Also, the edge guide mechanism has another problem that the recording medium gets caught on an endmost portion of the edge guide mechanism and thus does not normally fall.

The invention was made in view of the aforementioned problems, and provides a discharge roller, a conveyance apparatus, and a recording apparatus, which are enabled to prevent the blurring and the smearing of ink with a simple configuration.

To solve the aforementioned problems, according to one embodiment of the invention, a discharge roller for discharging a sheet member having a predetermined width includes a shaft member, a roller portion, and a pair of support members. The shaft member extends in a longitudinal direction. The shaft member supports the roller portion. Each of the support members includes a large diameter portion larger in a diameter than the roller portion.

With this configuration, the discharge roller can restrain apart of the sheet member, which has passed through the discharge roller, from hanging down. Consequently, the sheet member can be discharged while maintaining a horizontally extending state of the sheet member. Therefore, it can be delayed as much as possible to put (drop) a recording medium on which data is subsequently recorded on (onto) the previous recording medium discharged. Thus, adequate drying time needed to dry ink adhering to the recording medium can be ensured. Moreover, the blurring and the smearing of ink due to the contact between the recording media can be prevented.

Moreover, with this simple configuration, reduction in space can be achieved. Also, reduction in the cost can be achieved. Simultaneously, the blurring and the smearing of ink can be prevented.

According to one embodiment of the invention, a conveyance apparatus has the above described discharge roller.

According to one embodiment of the invention, a recording apparatus has the above described conveyance apparatus.

Accordingly, adequate ink drying time, during which ink adhering to a sheet member is sufficiently dried, can be ensured with a simple configuration. Also, the blurring and the smearing of ink due to the contact between the sheet members can be prevented.

### BRIEF DESCRIPTION OF THE DRAWINGS

FIG. 1 is a perspective view illustrating the external structure of a multifunction apparatus.

FIG. 2 is a cross-sectional view taken on line A-A shown in FIG. 1.

FIG. 3 is a view illustrating an inner part of the multifunction apparatus, which is viewed from an aperture thereof.

FIG. 4 is a perspective view illustrating the external structure of a sheet discharge roller.

FIG. 5A is a view illustrating the state of support members in a case where the support members support a soft recording medium; and FIG. 5B is a view illustrating the state of the support members in a case where the support members support a hard recording medium.

FIG. 6 is a view illustrating how a guide maintains a state in which both end portions of a recording medium are raised.

FIG. 7 is a perspective view illustrating the external structure of the discharge roller in a case where “rubber cups” are applied to the support members.

FIG. 8A is a perspective view illustrating the external structure of a discharge roller according to a modification 2. FIG. 8B is a partial enlarged view of the discharge roller shown in FIG. 8A.

FIG. 9 is a partial enlarged view of a discharge roller according to a modification 3, showing a support member 51′.

FIG. 10A is a partial enlarged view of another discharge roller according to the modification 3, showing a support member 51″. FIG. 10B is a perspective view of the other discharge roller according to the modification 3.

### DETAILED DESCRIPTION OF THE PREFERRED EMBODIMENTS

Hereinafter, embodiments of the invention will be described with reference to the accompanying drawings. Incidentally, in the embodiments described hereinbelow, the invention is applied to a multifunction apparatus that has a telephone function in addition to a printer function, a copier function, a scanner function, and a facsimile function. Incidentally, the invention may be applied to a recording apparatus such as an inkjet printer having only the printer function.

<Overall Configuration and Operation of Multifunction Apparatus>

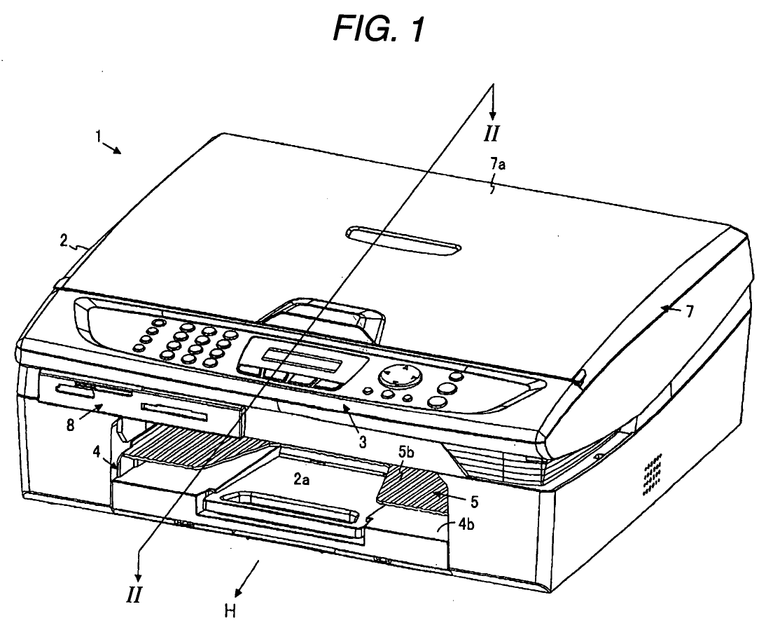

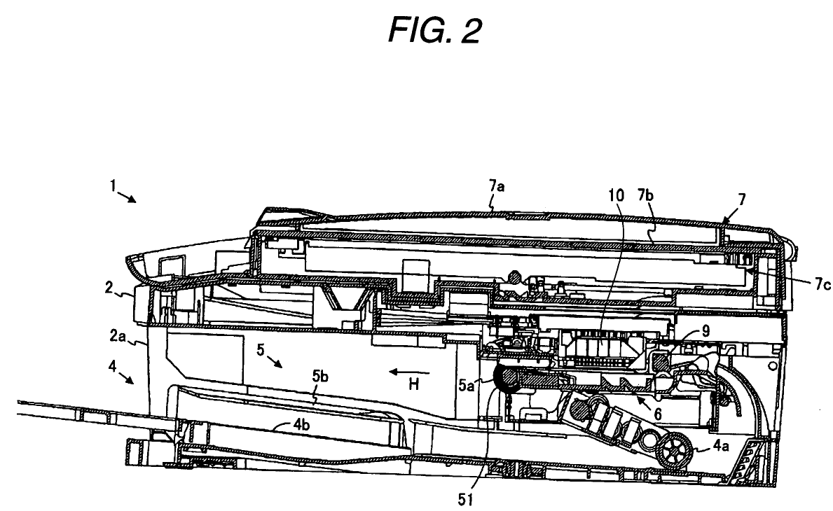

First, the overall configuration and an operation of the multifunction apparatus are described hereinbelow by referring to FIGS. 1 and 2.

FIG. 1 is a perspective view illustrating the external structure of the multifunction apparatus. FIG. 2 is a cross-sectional view taken on line II-II shown in FIG. 1. Incidentally, in the following description, the upward, downward, leftward, and rightward directions in FIG. 1 are expressed as upward, downward, leftward, and rightward directions in the multifunction apparatus, respectively, for convenience's sake. However, orientation of the multifunction apparatus in use is not limited thereby.

The multifunction apparatus 1 has a substantially rectangular parallelepiped-shaped casing 2 having a substantially rectangular aperture 2a in a front side thereof. The aperture 2a is formed so that a recording medium (such as recording paper and an OHP sheet) serving as a sheet member, which has a predetermined width, can be taken therein and out therefrom. Further, the multifunction apparatus 1 has an operating portion 3, a sheet feed portion 4, a sheet discharge portion 5, a recording portion 6, and an original reading portion 7. The operation portion 3 is provided at a frontwardly upward part of the casing 2. The sheet feed portion 4 and the sheet discharge portion 5 are provided on a part backwardly extending from the aperture 2a of the casing 2. The recording portion 6 is provided in the casing 2 (see FIG. 2). The original reading portion 7 is provided on a top part of the casing 2. Additionally, the multifunction apparatus 1 further has an external memory insertion portion 8, into which an external memory is inserted, at a downward side part of the operating portion 3.

The original reading portion 7 is configured in such a way as to be able to be upwardly and downwardly turned around a horizontal shaft provided at a rear end portion. As is seen when a top cover 7a is upwardly opened, an original mount glass 7b, on which an original is placed, is provided (see FIG. 2). An image scanner 7c for reading an original is provided under the original mount glass 7b. Data described in an original, which is placed on the original mount glass 7b, is read by the image scanner 7c. The read data is transmitted through, for example, a telephone line. Also, the multifunction apparatus 1 has a function of converting the data, which is transmitted thereto through the telephone line, into an image signal. This image signal is recorded on a recording medium in the recording portion 6. Thus, the multifunction apparatus 1 has both of a scanner function and a facsimile function. Also, the multifunction apparatus 1 has a copier (or copying) function. Data described on an original, which is placed on the original mount glass 7b, is read. A recording medium, on which the data is recorded through the recording portion 6, is discharged from a discharge portion 5.

An inner part of the aperture 2a of the multifunction apparatus 1 is formed in such a way as to be partitioned into upper and lower sections, as shown in FIG. 2. The lower section of the inner part of the aperture 2a functions as the sheet feed portion 4 for feeding a recording medium, while the upper section of the inner part of the aperture 2a functions as the sheet discharge portion 5 for discharging the recording medium, on which an image is recorded.

Further, when recording media are inserted into a sheet feed tray 4b of the sheet feed portion 4 and a recording (or printing) instruction is issued by using a button 3b provided on an operation panel of the operating portion 3 or a PC connected thereto, a topmost sheet of the recording media is separated by sheet feed roller 4a of the sheet feed portion 4. A conveyance roller 9 guides the separated recording medium to the recording portion 6. Then, a recording head 10 ejects predetermined ink onto the recording medium guided to the recording portion based on an image signal while the recording head reciprocates in the width direction of the recording medium, to thereby perform recording onto the recording medium. Subsequently, the recording medium recorded is discharged onto a sheet discharge tray 5b by a sheet discharge roller 5a serving as a discharge roller of a sheet discharge portion 5. Incidentally, the detailed configuration of the recording portion 6 does not have direct connection with the invention, so that the description of the detailed configuration thereof is omitted herein.

<Structure and Operation of Sheet Discharge Roller>

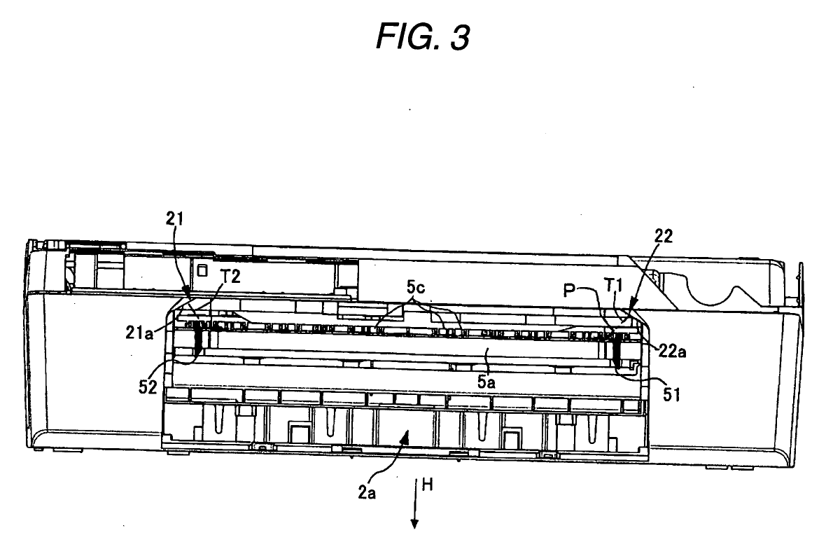

Next, structure and the operation of the sheet discharge roller are described in detail hereinbelow by referring to FIGS. 3 to 5.

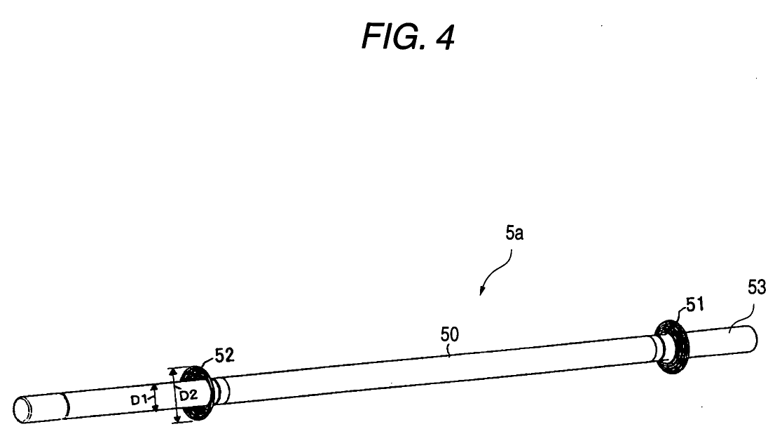

FIG. 3 is a view illustrating the inner part of the multifunction apparatus 1, which is viewed from the aperture 2a. FIG. 4 is a perspective view illustrating the external structure of the sheet discharge roller 5a.

Incidentally, FIG. 3 shows a state of the multifunction apparatus 1 from which the sheet feed tray 4a and the sheet discharge tray 5b of the inner part of the aperture 2a are demounted, and from which the top cover 7a of the original reading portion 7 is removed.

As shown in FIGS. 2 and 3, in the multifunction apparatus 1, the sheet discharge roller 5a for discharging a recording medium P, on which data is recorded by the recording portion 6, is disposed so that the axis of the sheet discharge roller 5a (thus, the longitudinal direction of the sheet discharge roller 5a) is perpendicular to a discharge direction H in which the recording medium P is discharged. This sheet discharge roller 5a is rotation-driven by a drive source (including a drive motor and a gear (not shown)) around the axis thereof. Also, plural spur rollers 5c, which abut against the sheet discharge roller 5a and rotate, are disposed above the sheet discharge roller 5a. The recording medium P, on which the data is recorded, is conveyed in the discharge direction H and discharged onto the discharge tray 5b while the recording medium P is sandwiched by the sheet discharge roller 5a and the spur rollers 5c.

The sheet discharge roller 5a includes a shaft member 53, pair of support members 51 and 52, and a roller portion 50. The support members 51 and 52 are disposed in the vicinity of both end portions of the shaft member 53, respectively. The support members 51 and 52 may be disposed on the shaft member 53 symmetrically with respect to a center of the shaft member 53 in the longitudinal direction (that is, a direction perpendicular to the discharge direction H). The roller portion 50 is supported by the shaft member 53. It is noted that the support members 51 and 52 may be disposed on the roller portion 50 instead of being disposed on the shaft member 53.

When the recording medium P is discharged, the support members 51 and 52 support both end portions (or edge portions) of the recording medium P in the direction perpendicular to the discharge direction H, and the roller portion 50 supports an intermediate portion (flat portion) of the recording medium P between the both end portions thereof. In this embodiment, these support members 51 and 52 are elastic members formed of coil springs (or spiral springs), and fixed to the vicinities of both end portions of the shaft member 53. Also, the roller portion 50 is made of an elastic material such as rubber or resin, and fixed to the shaft member 53. Accordingly, the support members 51 and 52 and the roller portion 50 rotate in response to the rotation of the shaft member 53.

Further, as shown in FIGS. 3 and 4, these support members 51 and 52 have effective diameters (in this embodiment, a diameter D2), which are larger than the effective diameter (in this embodiment, a diameter D1) of the roller portion 50. Here, the “effective diameter” means a diameter of an outer most portion (a large diameter portion) of each support member 51 and 52. The diameter of each support member 51 and 52 gradually increases toward each of the end portions of the support members 51 and 52 from the center side of the discharge roller 5a in the longitudinal direction of the discharge roller 5a. Thus, each of the support members 51 and 52 has a slope inclined at a predetermined angle with respect to a horizontal direction (an extending direction of the shaft member 53).

Furthermore, in a case where the support members 51 and 52 support a recording medium P having a specific stiffness, for example, a soft recording medium P such as copy paper, the support members 51 and 52 raise both the end portions T1 and T2 of the recording medium P, respectively, when the recording medium P is discharged. On the other hand, in a case where the support members 51 and 52 support a recording medium P, whose stiffness is higher than the specific stiffness, for instance, a hard recording medium P, such as a cardboard, the support members 51 and 52 bend (that is, are downwardly deformed) instead of raising both the end portions T1 and T2 of this recording medium P. Incidentally, the degree of the stiffness of the recording medium P, which causes the support members 51 and 52 to bend, is preliminarily calculated and the support members 51 and 52 are designed properly based on the calculation result. In order for the support members 51 and 52 to satisfy the above conditions, the support members 51 and 52 are designed with considering a Young's modulus and a biasing force of material of the support members, and a bending resistance, a flexural rigidity, and a Young's modulus of the recording medium P.

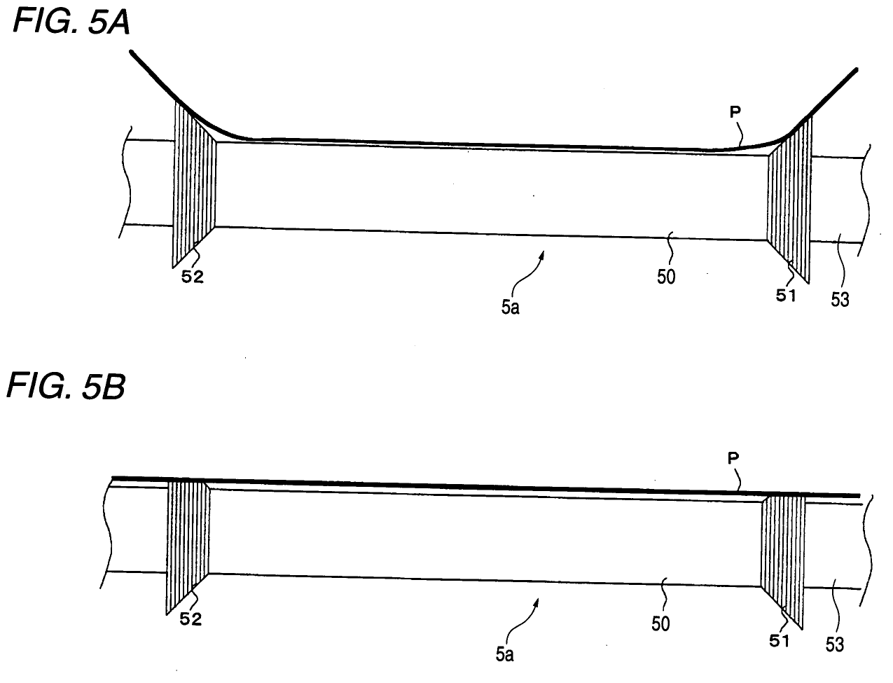

FIG. 5A is a view illustrating the state of support members 51 and 52 in a case where the support members 51 and 52 support a soft recording medium P. FIG. 5B is a view illustrating the state of the support members 51 and 52 in a case where the support members 51 and 52 support a hard recording medium P.

For example, when the soft recording medium P such as copy paper is discharged by the discharge roller 5a, both the end portions T1 and T2 of the recording medium P are raised by the support members 51 and 52, respectively (that is, the support members 51 and 52 support the recording medium P without bending), and discharged onto the sheet discharge tray 5b, while being curved substantially like a letter “U”, as illustrated in FIG. 5A. Thus, a part of the soft recording medium P, which has passed through the discharge roller 5a, is restrained from hanging down (that is, an end portion of this part is restrained from hanging down under the own weight thereof). Consequently, the recording medium P is discharged while the recording medium P is maintained in a horizontally extending (or straight) condition as much as possible.

On the other hand, when the hard recording medium P such as a cardboard is discharged by the discharge roller 5a, the support members 51 and 52 bend and both the end portions T1 and T2 of the recording medium P are not raised by the support members 51 and 52 (that is, the support members 51 and 52 bend and support the recording medium P), and discharged onto the sheet discharge tray 5b, as illustrated in FIG. 5B. That is, the support members 51 and 52 are downwardly bent due to the stiffness of the recording medium P. Consequently, a part of the recording medium P, which has passed through the discharge roller 5a, is discharged without hanging down due to its stiffness, while maintained in a horizontally extending state as much as possible.

Further, as shown in FIG. 3, guides 21 and 22 respectively having slopes 21a and 22a are disposed on the inner part of the aperture 2a of the multifunction apparatus 1. The slopes 21a and 22a of the guides 21 and 22 guide the recording medium P in the discharge direction H while abutting against the recording medium P to maintain a state that both the end portions T1 and T2 of the recording medium P are raised by the discharge roller 5a (that is, the support members 51 and 52).

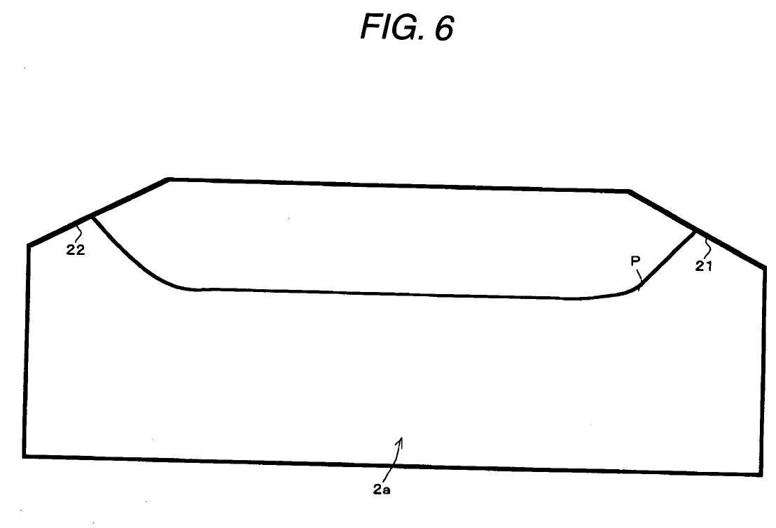

FIG. 6 is a view illustrating how the guides 21 and 22 maintain a state in which both the end portions T1 and T2 of the recording medium P are raised.

In the case where the soft recording medium P, both end portions T1 and T2 of which are raised by the support members 51 and 52, is discharged, the recording medium P is guided in the discharge direction H and discharged while the state, in which both end portions thereof are raised, is maintained (that is, the horizontally extending state is maintained as much as possible) by the guides 21 and 22, as illustrated in FIG. 6. Therefore, the part of the soft recording medium P, which has passed through the discharge roller 5a, is restrained still more from hanging down (that is, an end portion of the recording medium P is restrained from hanging down loosely). Incidentally, such guides 21 and 22 may be either formed integrally with the casing 2 of the multifunction apparatus 1 or provided separately from the casing 2.

As described above, according to the aforementioned embodiment, the support members 51 and 52 for supporting both the end portions T1 and T2 in a direction perpendicular to the discharge direction H of the recording medium P are provided on the discharge roller 5a. For example, when a soft recording medium P is discharged, both the end portions T1 and T2 are raised by the support members 51 and 52, respectively. Thus, the part of the soft recording medium P, which has passed through the discharge roller 5a, is restrained from hanging down, so that the recording medium P can be discharged with maintaining the horizontally extending state of the recording medium P. Therefore, it can be delayed as much as possible to put (drop) a recording medium on which data is subsequently recorded on (onto) the last recording medium discharged on the sheet discharge tray 5b. Thus, adequate drying time needed to dry ink adhering to the recording medium can be ensured. Moreover, the blurring and the smearing of ink due to the contact between the recording media can be prevented.

Additionally, there is no need for a complex configuration, such as the configuration of the edge guide mechanism disclosed in U.S. Pat. No. 6,042,106. Reduction in necessary space can be achieved by a simple configuration in which the support members 51 and 52 are provided in the vicinities of both the end portions of the shaft member 53. Thus, the cost thereof can be reduced. Simultaneously, the blurring and the smearing of ink can be prevented. Additionally, this embodiment can prevent an occurrence of the problems of the recording medium edge guide mechanism disclosed in U.S. Pat. No. 6,042,106, that is, the problems that the recording medium gets caught on an endmost portion thereof the edge guide mechanism and is not discharged on the sheet discharge tray.

Also, the guides 21 and 22 respectively having the slopes 21a and 22a for guiding the soft recording medium P in the discharge direction H while maintaining a state that both the end portions T1 and T2 of the recording medium P are respectively raised by the support members 51 and 52 of the discharge roller 5a, are formed on the inner part of the aperture 2a of the multifunction apparatus 1. Thus, a combination of the guides 21, 22 and the support members 51, 52 restrain the part of the soft recording medium P, which has passed through the discharge roller 5a, still more from hanging down. Consequently, the recording medium P can be discharged while the horizontally extending state of the recording medium P is maintained. The blurring and the smearing of ink can be prevented.

On the other hand, when, for example, the hard recording medium P is discharged, the part of the soft recording medium P, which has passed through the discharge roller 5a, is prevented from hanging down due to its stiffness. Thus, the horizontally extending state of the recording medium P is maintained due to the bending of the support members 51 and 52. Consequently, more effective handling of discharge of recording paper can be achieved according to the stiffness of the recording paper.

(Modification 1)

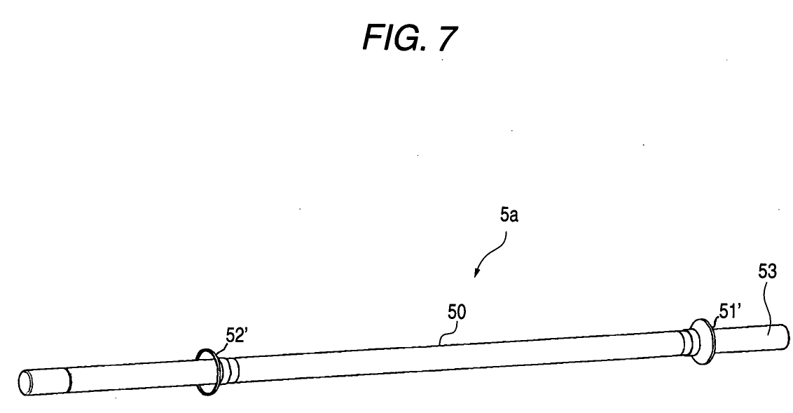

Incidentally, although coil springs are used as the support members 51 and 52 in the aforementioned embodiment by way of example, the support members are not limited thereto. Other elastic members may be applied to the support members. For instance, “rubber cups” (that is, cup-shaped rubber members), as shown in FIG. 7, may be used as the support members (the operations of the “rubber cups” are the same as that of the coil springs).

(Modification 2)

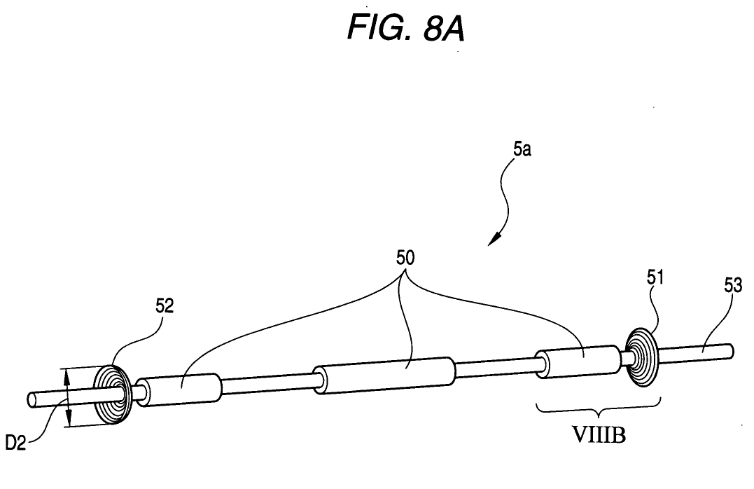

In the aforementioned embodiment, the roller portion 50 extends continuously in the longitudinal direction of the shaft member 53, that is, is formed of a single member. However, the roller portion is not limited thereto. For example, the roller portion may be separated into plural members 50′ as shown in FIG. 8A. Number of the plural roller portions 50′, width of each roller portion 50′, and intervals between adjacent roller portions 50′ are not limited so long as when the discharge roller 5a discharges a recording medium P, the recording medium P is not caught by recesses defined between adjacent roller portions 50′. FIG. 8B is a partial enlarged view of the discharge roller 5a′ shown in FIG. 8A. As with the aforementioned embodiment, each of the support member 51, 52 has an effective diameter (a diameter D2), which is larger than that (a diameter D1) of each roller portion 50′. With the configuration described above, it is possible to reduce a total amount of the roller portions 50′, resulting in reducing a cost of the discharge roller 5a.

(Modification 3)

Further, each of the support members 51 and 52 has such a structure (or shape) that the effective diameter thereof gradually increases toward the associated end of the discharge roller 5a from the center side of the discharge roller 53 in the longitudinal direction thereof, in the aforementioned embodiment by way of example. However, the structure (or shape) of each of the support members is not limited thereto.

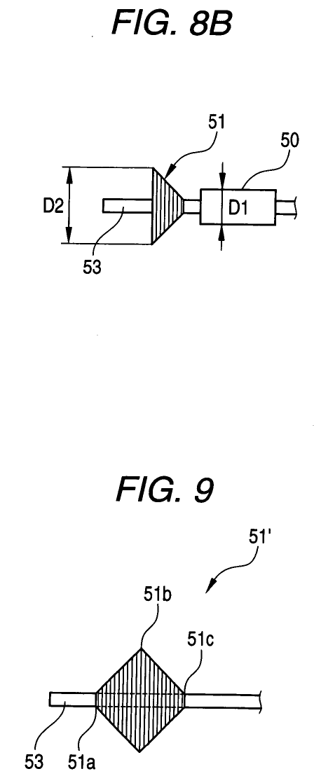

For example, as shown in FIG. 9, each support member 51′, 52′ has such a structure that (a) a diameter thereof gradually increases from an outer side end 51a of each support member 51′, 52′ toward a center side of the discharge roller 5a; (b) the effective diameter thereof has an effective diameter D2 at a position 51b between the outer side end 51a and an inner side end 51c; (c) the effective diameter D2 of each support member 51′, 52′ is larger than the effective diameter D1 of the roller portion 50, and (d) the diameter thereof decreases gradually from the position 51b toward the center side of the discharge roller 5a. In section taken along the longitudinal direction of the shaft member 53, an outline of each support member 51′, 52′ has a substantially rectangle shape.

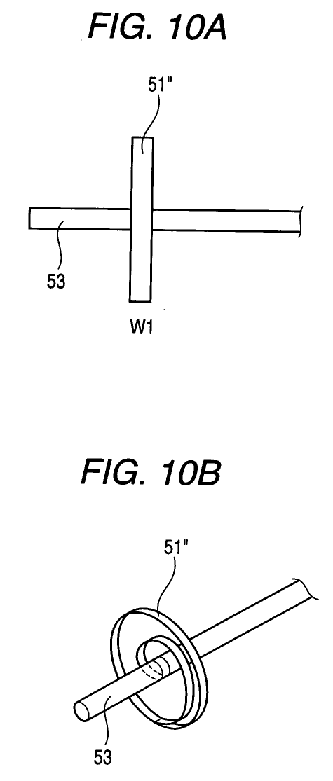

Alternatively, as shown in FIG. 10A, each support member 51″, 52″ has such a structure that a diameter thereof is substantially constant. In other words, an outline of each support member 51″ and 52″ has a cylindrical shape. Each support member 51″ and 52″ are formed, for example, by winding a stripe coil spring having a width w1 around the shaft member 53 as shown in FIG. 10B.

Particularly, in a case where an effective diameter of the shaft member is different from that of the roller portion and the support member is disposed on the shaft member, relief space is defined naturally to which the support members are displaced when the support members are deformed. Therefore, when a hard recording medium is discharged, the support members do not interfere with the discharge of the recording medium.

1. A discharge roller for discharging a sheet member having a predetermined width, the discharge roller comprising:
a shaft member extending in a longitudinal direction;
a roller portion supported by the shaft member; and
a pair of support members each of which comprises a large diameter portion larger in a diameter than the roller portion.

2. The discharge roller according to claim 1, wherein the support members are disposed on the roller portion.

3. The discharger roller according to claim 1, wherein the support members are disposed on the shaft member.

4. The discharge roller according to claim 1, wherein the large diameter portion of each support member includes one end of each support member.

5. The discharge roller according to claim 4, wherein the other end of each support member is closer to a center of the shaft member than the one end of each support member.

6. The discharge roller according to claim 4, wherein the diameter of each support member increases gradually from the other end to the one end.

7. The discharge roller according to claim 1, wherein the support members support both end portions of the sheet member, respectively when the sheet member is being discharged in a discharge direction perpendicular to the longitudinal direction.

8. The discharge roller according to claim 1, wherein each of the support members comprises an elastic member.

9. The discharge roller according to claim 1, wherein each of the support members comprises a coil spring.

10. The discharge roller according to claim 1, wherein each of the support members comprises a rubber.

11. The discharge roller according to claim 1, wherein:
the support members are configured to raise both end portions of the sheet member when the support members support the sheet member being equal to or less than a predetermined value in stiffness; and
the support members are configured to bend when the support members support the sheet member being larger than the predetermined value in stiffness.

12. The discharge roller according to claim 11, wherein the support member is configured to bend without raising the both end portions of the sheet member.

13. The discharge roller according to claim 1, wherein the roller portion comprises a plurality of roller portions separated from each other.

14. The discharge roller according to claim 3, wherein the roller portion comprises a plurality of roller portions separated from each other.

15. The discharge roller according to claim 13, wherein each support member is farther from a center of the shaft member than the roller portions.

16. The discharge roller according to claim 1, wherein the diameter of each support member increases from both ends thereof to the large diameter portion gradually.

17. The discharge roller according to claim 1, wherein an outline of each support member has a cylindrical shape.

18. A conveyance apparatus comprising:
a discharge roller that discharges a sheet member having a predetermined width, the discharge roller comprising:
a shaft member extending in a longitudinal direction;
a roller portion supported by the shaft member; and
a pair of support members each of which comprises a large diameter portion larger in a diameter than the roller portion.

19. The conveyance apparatus according to claim 18, further comprising:
a guide having a slope that guides the sheet member while abutting against an edge of the sheet member to maintain a state where both end portions of the sheet member are raised by the discharge roller while guiding the sheet member.

20. The conveyance apparatus according to claim 18, further comprising:
a spur roller that faces the discharge roller, wherein:
the discharge roller and the spur roller operate in conjunction with each other to discharge the sheet member.

21. A recording apparatus comprising:
an image forming section that forms an image on a sheet member;
a conveyance apparatus that conveys the sheet member to a recording region and discharges the sheet member from the recording region, the conveyance apparatus comprises:
a discharge roller that discharges the sheet member from the recording apparatus, the discharge roller disposed downstream of the image forming section in a conveyance direction, the discharge roller comprising:
a shaft member extending in a longitudinal direction;
a roller portion supported by the shaft member;
and
a pair of support members each of which comprises a large diameter portion larger in a diameter than the roller portion.

22. The recording apparatus according to claim 12, wherein the conveyance apparatus further comprises a guide having a slope that guides the sheet member while abutting against an edge of the sheet member to maintain a state where both end portions of the sheet member are raised by the discharge roller.

23. The recording apparatus according to claim 21, wherein the image forming section comprises an inkjet recording head.
